(19) United States
(12) Patent Application Publication
(10) Pub. No.: US 2025/0021616 A1
(43) Pub. Date: Jan. 16, 2025

(54) SYSTEM AND METHOD FOR OPTIMIZING CALCULATION OF BUTTERFLY TRANSFORMS BY A PROCESSING UNIT

(71) Applicant: DECI.AI LTD., Givataim (IL)

(72) Inventor: Oren TROPP, Raanana (IL)

(73) Assignee: DECI.AI LTD., Givataim (IL)

(21) Appl. No.: 18/711,063

(22) PCT Filed: Nov. 17, 2022
(86) PCT No.: PCT/IL2022/051224

§ 371 Date: May 16, 2024

Related U.S. Application Data
(60) Provisional application No. 63/280,731, filed on Nov. 18, 2021.

(51) Int. Cl. G06F 17/14; G06F 17/16

(52) U.S. Cl. CPC G06F 17/142; G06F 17/16

(57) ABSTRACT

Embodiments of the invention may include a system and method of automatically optimizing calculation of a butterfly transform by a processing unit. The processing unit may be adapted to perform atomic [N×N] matrix-matrix multiplication operations. Embodiments of the invention may include: receiving an input data matrix of dimensions [M×B], representing a batch of B input data vectors, each of length M; arranging the input data matrix into S section matrices of dimensions [N rows×K columns], wherein K>=N and K<=B; calculating a plurality of [N×N] coefficient matrices representing coefficients of the butterfly transform; and performing an iterative process of atomic [N×N] matrix multiplication operations between the [N×K] section matrices and corresponding [N×N] coefficient matrices, to produce an output matrix O, where output matrix O may represents a result of the butterfly transform on the batch of B input vectors.

### CROSS-REFERENCE TO RELATED APPLICATIONS

This application claims the benefit of priority under 35 U.S.C. § 119 (e) of U.S. Provisional Application No. 63/280,731, filed on Nov. 18, 2021, entitled “SYSTEM AND METHOD FOR OPTIMIZING CALCULATION OF BUTTERFLY TRANSFORMS BY A PROCESSING UNIT”. The contents of the above applications are all incorporated by reference herein in their entirety.

### FIELD OF THE INVENTION

The present invention relates generally to performing calculations on a computing device. More specifically, the present invention relates to optimizing calculation of butterfly transforms by a processing unit.

### BACKGROUND OF THE INVENTION

As known in the art, calculation of butterfly transforms such as Discrete Fourier Transforms (DFT) Discrete Cosine Transform (DCT) transforms, and the like are essential building blocks in a multitude of engineering applications, including for example applications of signal processing and image processing.

State-of-the-art computational devices such as the currently available Nvidia Tensor Core Graphic Processing Unit (GPU) facilitate performance of atomic matrix-matrix multiplication operations.

### SUMMARY OF THE INVENTION

As elaborated herein, Embodiments of the invention may employ a synergy between the architecture of currently available computing devices, which facilitate atomic matrix-matrix multiplication operations, and a novel algorithm for calculation of butterfly transforms, to boost the efficiency (e.g., increase a yield, reduce a latency, etc.) of butterfly transform computation.

Embodiments of the invention may include a method of automatically optimizing calculation of a butterfly transform by a processing unit, where the processing unit adapted to perform atomic [N×N] (e.g., 16 elements by 16 elements) matrix-matrix multiplication operations.

According to some embodiments, the processing unit may be configured to receive an input data matrix of dimensions [M×B], representing a batch of B input data vectors, each of length M. The processing unit may arrange the input data matrix into S section matrices of dimensions [N×K] (e.g., [N rows×K columns]), where K>=N and K<=B. For example, S may be defined, or calculated as the division of M by N (e.g., (M/N)), rounded to the next power of 2. For example, if M=256 and N=16, then S may be 16. In another example, if M=1020 and N=16, then S may be 64.

It may be appreciated that the terms “rows” and “columns” may be used herein interchangeably to indicate examples of matrix dimensions or indices. A person skilled in the art may implement embodiments of the invention as elaborated herein, using alternative dimensions (e.g., using rows instead of columns and vice versa), with the appropriate adjustments.

According to some embodiments, the processing unit may calculate, or receive (e.g., from an input device) a plurality of [N×N] coefficient matrices, representing coefficients of the butterfly transform. The processing unit may perform an iterative process of atomic [N×N] matrix multiplication operations between the [N×K] section matrices and corresponding [N×N] coefficient matrices, to produce an output matrix O, as elaborated herein. The output matrix O may represent a result of the butterfly transform on the batch of B input vectors.

According to some embodiments the processing unit may include a cache memory device of a predefined size CS. In such embodiments, the processing unit may be configured to select the value of K, so as to optimally utilize cache memory size CS for the atomic [N×N] matrix-matrix multiplication operations.

According to some embodiments, the processing unit may calculate or determine a number of iterations R of the iterative process based on M. For example, for a value of 16<M<=256, R may be set as 2, and for a value of 256<M<=4096, R may be set as 3. The processing unit may repeat the iterative process R number of iterations.

In each iteration or stage, and for each section matrix, the processing unit may perform at least one (e.g., exactly one, if N=K) atomic [N×N] matrix-matrix multiplication operation between the section matrix and a corresponding coefficient matrix, to obtain S [N×K] interim matrices.

According to some embodiments, in each iteration (or between each pair of consecutive stages or iterations), the processing unit may rearrange the N rows of the S interim matrices to produce S new [N×K] section matrices. The processing unit may use the S new [N×K] section matrices, as input for a subsequent iteration or stage, as elaborated herein.

According to some embodiments, when an index of the current iteration is R (e.g., corresponding to the last iteration, or stage), then the processing unit may rearrange the N rows of the S interim matrices to produce the output matrix O.

Additionally, or alternatively, when an index of the current iteration is R, then the processing unit may concatenate the N rows of the S interim matrices to produce the output matrix O.

Additionally, or alternatively, if otherwise (e.g., if the index of the current iteration is smaller than R), then the processing unit may rearrange the N rows of the S interim matrices to produce S new [N×K] section matrices, as input for a subsequent iteration.

According to some embodiments, the processing unit may rearrange the S interim matrices by calculating a bin size parameter value, based on the index of the current iteration; for each row of the S interim matrices, calculating a modulus of an index of the row, based on the bin size parameter value; and rearranging the [S×N] rows of the S [N×K] interim matrices to produce S new [N×K] section matrices such that each new [N×K] section matrix include rows of the S interim matrices that correspond to the same calculated modulus.

According to some embodiments, the processing unit may rearrange the N rows of an [N×K] interim matrix by maintaining the S [N×K] interim matrices in the cache memory of a single kernel of the processing unit; rearranging rows of the S [N×K] interim matrices to produce S new [N×K] section matrices; and maintaining the S new [N×K] section matrices in the cache memory of the single kernel for the subsequent iteration.

According to some embodiments, the processing unit may perform multiplication operations between an [N×K] section matrix and a [N×N] coefficient matrix by: dividing the [N×K] section matrix to a plurality of [N×N] sub-matrices; for each sub-matrix, performing atomic [N×N] matrix multiplication between the sub-matrix and the corresponding [N×N] coefficient matrix; repeating the atomic [N×N] matrix multiplication for all sub-matrices of the section matrix; and accumulating output of the atomic matrix multiplications in the cache memory of a single kernel of the processing unit, to produce at least one interim matrix of the S interim matrices.

According to some embodiments, the butterfly transform may include, for example a Fast Fourier Transform (FFT), an Inverse Fast Fourier Transform (IFFT), a Discrete Fourier Transform (DFT), and an Inverse Discrete Fourier Transform (IDFT). In such embodiments, the processing unit may receive an input data matrix by receiving an input vector Vi; and reshaping the initial input vector Vi to produce the input data matrix of dimensions [M×B]. Additionally, in such embodiments, the processing unit may reshaping output matrix O, to produce an output vector Vo, representing a result of the butterfly transform on input vector Vi.

According to some embodiments, the processing unit may be a Tensor Core Graphic Processing Unit (GPU), configured to perform the at least one [N×N] matrix (or “matrix-matrix”) multiplication in a single computing cycle.

According to some embodiments, the butterfly transform may include, for example, a Fast Fourier Transform (FFT), an Inverse Fast Fourier Transform (IFFT), a Discrete Fourier Transform (DFT), an Inverse Discrete Fourier Transform (IDFT), a Discrete Cosine Transform (DCT), an Inverse Discrete Cosine Transform (IDCT), a Discrete Sine Transform (DST), and an Inverse Discrete Sine Transform (IDST).

Embodiments of the invention may include a system for automatically optimizing calculation of a butterfly transform. Embodiments of the system may include a non-transitory memory device, wherein modules of instruction code are stored, and at least one processor associated with the memory device, and configured to execute the modules of instruction code. Upon execution of said modules of instruction code, the at least one processor may be configured to: receive an input data matrix of dimensions [M×B], representing a batch of B input data vectors, each of length M; arrange the input data matrix into S section matrices of dimensions [N rows×K columns], wherein K>=N and K<=B; calculate a plurality of [N×N] coefficient matrices representing coefficients of the butterfly transform; and perform an iterative process of atomic [N×N] matrix multiplication operations between the [N×K] section matrices and corresponding [N×N] coefficient matrices, to produce an output matrix O, where the output matrix O may represent a result of the butterfly transform on the batch of B input vectors.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram, depicting a computing device which may be included in a system for optimizing calculation of butterfly transforms, according to some embodiments;

FIG. 2 is a schematic drawing depicting a butterfly transform calculation diagram, as known in the art;

FIG. 3 is a block diagram, which depicts an example of a practical application of a system for optimizing calculation of butterfly transforms, according to some embodiments of the invention;

FIG. 4 is a schematic diagram depicting flow of data in a butterfly transform calculation module, that may be included in a system for optimizing calculation of butterfly transforms, according to some embodiments of the invention;

FIG. 5 is a schematic diagram, depicting an example of calculation of a stage in the butterfly transform calculation module, according to some embodiments of the invention;

FIG. 6A is a schematic diagram, depicting an example of a swizzle function, which may be included in a butterfly transform calculation module, according to some embodiments of the invention;

FIG. 6B is a schematic diagram, depicting an example of a computation of a butterfly transform according to some embodiments of the invention;

FIG. 7 is a schematic diagram depicting a system for optimizing calculation of butterfly transforms, according to some embodiments of the invention; and

FIG. 8 is a flow diagram depicting a method of optimizing calculation of a butterfly transform, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

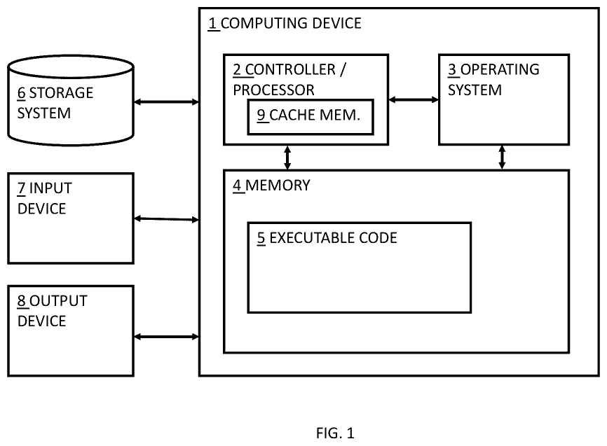

Reference is now made to FIG. 1, which is a block diagram depicting a computing device, which may be included within an embodiment of a system for optimizing calculation of butterfly transforms, according to some embodiments.

Computing device 1 may include a processor or controller 2 that may be, for example, a central processing unit (CPU) processor, a chip or any suitable computing or computational device, an operating system 3, a memory 4, executable code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of possibly different memory units. Memory 4 may be a computer or processor non-transitory readable medium, or a computer non-transitory storage medium, e.g., a RAM. In one embodiment, a non-transitory storage medium such as memory 4, a hard disk drive, another storage device, etc. may store instructions or code which when executed by a processor may cause the processor to carry out methods as described herein.

Executable code 5 may be any executable code, e.g., an application, a program, a process, task, or script. Executable code 5 may be executed by processor or controller 2 possibly under control of operating system 3. For example, executable code 5 may be an application that may optimize calculation of butterfly transforms as further described herein. Although, for the sake of clarity, a single item of executable code 5 is shown in FIG. 1, a system according to some embodiments of the invention may include a plurality of executable code segments similar to executable code 5 that may be loaded into memory 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Data pertaining to calculation of butterfly transforms may be stored in storage system 6, and may be loaded from storage system 6 into memory 4 where it may be processed by processor or controller 2. In some embodiments, some of the components shown in FIG. 1 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

Cache memory 9 may be or may include for example, a Layer 1 (L1) cache module, a Layer 2 (L2) cache module and/or a Layer 3 (e.g., L3) cache memory module, as known in the art. Cache memory 9 may include, for example, an instruction cache memory space and/or a data cache memory space, and may be configured to cooperate with one or more processors (such as element 2) and/or one or more processing cores to execute at least one method according to embodiments of the present invention. Cache memory 9 may typically be implemented on the same die or chip as processor 2 and may thus be characterized by a memory bandwidth that may be higher than that of memory 4 and storage system 6.

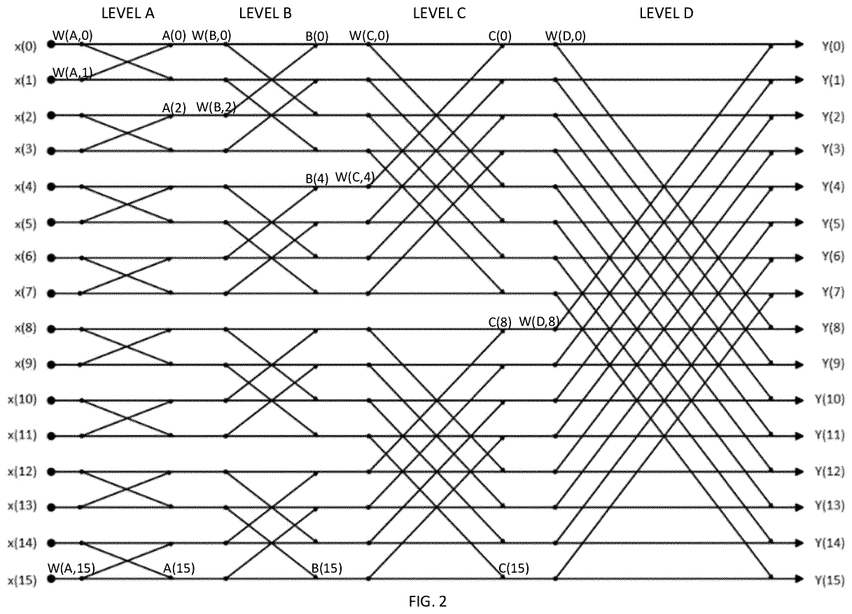

Reference is now made to FIG. 2, which is a schematic drawing depicting a butterfly transform calculation diagram, as known in the art. The name “butterfly” is derived from the shape of the data-flow diagram as depicted in FIG. 2.

The terms “butterfly transform” and “butterfly transform calculation” may be used herein interchangeably to refer to any one of a group of mathematical transforms that may be performed using a butterfly diagram such as the diagram in the example of FIG. 2.

For example, a butterfly transform as used herein may refer to a Fast Fourier Transform (FFT), an Inverse Fast Fourier Transform (IFFT), a Discrete Fourier Transform (DFT), an Inverse Discrete Fourier Transform (IDFT), a Discrete Cosine Transform (DCT), an Inverse Discrete Cosine Transform (IDCT), a Discrete Sine Transform (DST), an Inverse Discrete Sine Transform (IDST), and the like.

In the example depicted in FIG. 2, a butterfly transform calculation (e.g., DCT) may be applied on a 16-element digital input vector X(e.g., X(15) . . . X(0)). The output of the butterfly transform calculation is depicted as a 16-element digital vector Y (e.g., Y(15) . . . Y(0)).

As shown in the example of FIG. 2, a butterfly transform may include a plurality of levels, denoted herein as levels A, B, C and D. Each level may receive 16 elements of input from a previous level (or from input vector X), and may perform 16 pairs of weighted sum operations (e.g., multiply-access (MAC) operations) with predefined weight values, to produce either (a) interim inputs to the subsequent level, or (b) the output vector Y. The weight values of FIG. 2 are denoted herein as W(i,j), where i represents the level (e.g., iϵ{A, B, C, D}) and j represents the index of a weight value within a level (e.g., jϵ[0, 15]).

For example, to produce a first output of level A (denoted A(0)), which is also the first interim input to subsequent level B, the butterfly transform process may calculate the weighted sum operation: A(0)=(W (A, 0)*X(0))+(W(A, 1)*X(1)).

In another example, to produce the first output element of level D, which is also the first output element of vector Y (denoted Y(0)), the butterfly transform process may calculate the weighted sum operation: Y(0)=(W(D, 0)*C(0))+(W(D,8)*C(8)), where: W(D, 0) is the first weight value of level D; W(D, 8) is the ninth weight value of level D; C(0) is the first element of the output of level C; and C(8) is the ninth element of the output of level C.

As known in the art, the number of required levels in a butterfly diagram is derived from the number of elements in the incoming vector, according to Eq. 1, below:

$$N \text{=<} {2}^{L} , \qquad Eq . 1$$

where N is the number of elements, and L is the number of levels. For example, as shown in FIG. 2, a 4-level butterfly diagram may represent, or facilitate computation of a butterfly transform of a 16—element input vector. An input vector of between 17 and 32 elements would require a 5-level butterfly diagram, etc.

Other indices and values have been omitted from the example of FIG. 2 for the purpose of clarity.

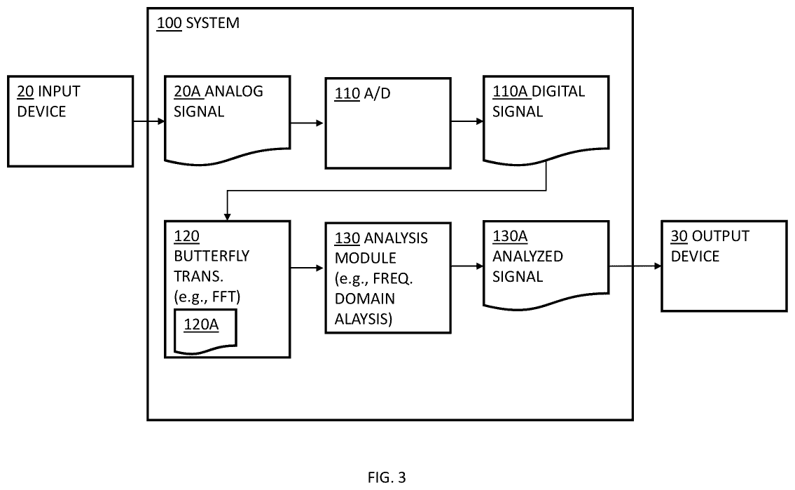

Reference is now made to FIG. 3, which depicts an example of a practical application of a system 100 for optimizing calculation of butterfly transforms, according to some embodiments of the invention. System 100 may be implemented as a software module, a hardware module, or any combination thereof. For example, system 100 may be or may include a computing device such as element 1 of FIG. 1, and may be adapted to execute one or more modules of executable code (e.g., element 5 of FIG. 1) to optimize calculation of butterfly transforms, as further described herein.

As shown in FIG. 3, arrows may represent flow of one or more data elements to and from system 100 and/or among modules or elements of system 100. Some arrows have been omitted in FIG. 3 for the purpose of clarity.

As known in the art, calculation of butterfly transforms such as FFT transforms and DCT transforms are essential building blocks in a multitude of engineering applications, including for example applications of signal processing and image processing.

For example, as depicted in the non-limiting example of FIG. 3, system 100 may receive from an input device 20 (e.g., a sensor), a real-world, analog electronic signal 20A. System 100 may include (or alternatively—be associated with) an analog to digital (A/D) module, configured to perform an A/D conversion 110 of analog electronic signal 20A, to obtain a digital version 110A of analog signal 20A.

System 100 may include a butterfly transform calculation module 120, configured to apply a butterfly transform calculation such as FFT or DCT on digital signal 110A, to obtain a digital, transformed version 120A of digital signal 110A, as elaborated herein.

Pertaining to the example of FFT, signal 120A may include a digital, frequency-domain representation of signal 20.

System 100 may include (or alternatively—be associated with) an analysis module 130, adapted to perform further, application-specific analysis of signal 120A, to produce an analyzed signal 130A. Pertaining to the same example, analysis module 130 may perform frequency-domain filtering or frequency-domain compression of signal 120A, to produce a respective filtered or compressed signal 130A, and transmit analyzed signal 130A to another module or computing device for any additional application-specific purpose.

According to some embodiments, butterfly transform module 120 may be or may include a computing device such as computing device 1 of FIG. 1, that may be configured to perform computation of matrix multiplication as an atomic operation. For example, butterfly transform module 120 may be, or may include a computing device 1 such as an Nvidia Tensor Core Graphic Processing Unit (GPU).

As known in the art, the term “atomic” may be used in this context to indicate an operation that may be performed by a processing unit (e.g., a processor kernel) in a single executable command, or a single computing cycle.

For example, butterfly transform module 120 may be, or may include a GPU (e.g., a Tensor Core GPU) that may be configured to perform at least one [N×N] matrix multiplication operation in a single computing cycle. In other words, butterfly transform module 120 may be adapted to utilize high-performance libraries, to perform complex operations such as multiplication of a first [16×16] matrix by a second [16×16] matrix, in an atomic manner.

As elaborated herein, butterfly transform module 120 may be configured to implement computation of a butterfly transform (e.g., DCT) as a series of matrix-matrix multiplication, using the atomic matrix multiplication capability of computing device 1.

Applicants have experimentally shown that usage of such hardware architecture, in conjunction with the appropriate high-performance libraries for atomic matrix-matrix multiplication, may improve throughput of butterfly transform calculations by as much as a factor of 8, in relation to currently available systems and methods of butterfly transform calculation.

Additionally, and as elaborated herein, butterfly transform module 120 may be configured to optimally utilize a cache memory (e.g., cache 9 of computing device 1), to perform the series of matrix-matrix multiplication from cache memory 9. Thus, butterfly transform module 120 may minimize processor access to an external memory device (e.g., memory 4 and/or storage 6 of FIG. 1), and may thus further improve throughput of butterfly transform calculations in relation to currently available systems and methods of butterfly transform calculation.

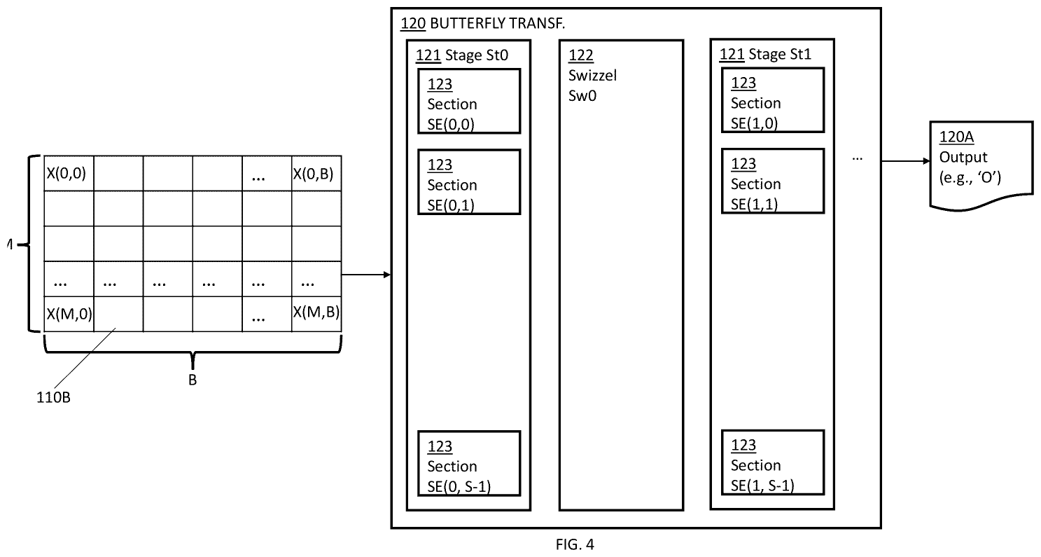

Reference is now made to FIG. 4, which is a schematic diagram depicting flow of data in a butterfly transform calculation module (e.g., butterfly transform calculation module 120 of FIG. 3), that may be included in a system 100 for optimizing calculation of butterfly transforms, according to some embodiments of the invention.

According to some embodiments, butterfly transform calculation module 120 (or butterfly module 120, for short) may include one or more stage calculation modules 121 (or stage 121, for short).

In the non-limiting example of FIG. 4, butterfly module 120 includes two stages, denoted stage 121-ST0, and stage 121-ST1. As elaborated herein, in each stage (e.g., ST0, ST1), butterfly module 120 may implement calculation of a plurality of butterfly transform levels such as levels A-D of FIG. 2.

Pertaining to the example of FIG. 2, in the first 4 layers of a butterfly transform as depicted in this example, the 16 consecutive input elements of input vector X(15:0) may be combined to create a 16 element output Y(15:0), using 128 multiplication operations. As all these operations are linear, the 16 element output Y(15:0) may be calculated, or expressed as an outcome of a multiplication of the 16 inputs X(15:0) with a 16×16 matrix, using 16×16=256 operations.

As elaborated herein, butterfly transform module 120 may be, or may include a computing device 1 adapted to perform atomic [N×N] matrix multiplication operations. The terms “matrix multiplication”, “matrix-matrix multiplication” or “[N×N] matrix multiplication” may be used herein interchangeably to refer to an algebraic function of multiplication between two matrices (e.g., each of size [N×N]). For example, computing device 1 may include a processing unit such as an Nvidia Tensor Core GPU, configured to perform matrix multiplication between two [(N=16)×(N=16)] matrices, as atomic operations.

In such embodiments, butterfly transform module 120 may perform the 256 multiplications as an atomic operation. In other words, each stage (e.g., ST0) of butterfly module 120 may utilize the atomic matrix multiplication capabilities of computing device 1 (e.g., a Tensor Core GPU), to implement 4 layers of a 16-element butterfly transform, as in the example of FIG. 2.

As shown in FIG. 4, butterfly module 120 may include, between each pair of adjacent stages 121 (e.g., ST0 and ST1), a swizzling module 122 (e.g., denoted Swizzle 122-SW0). According to some embodiments, swizzling module 122 (e.g., SW0) may be configured to swizzle, or rearrange the output of a first stage 121 (e.g., ST0), to serve as input to a subsequent stage 121 (e.g., ST1). Swizzling module 122 (e.g., SW0) may thus enable the next levels (e.g., the levels of ST1) to be computed recursively in the same way.

In other words, the swizzling, or rearrangement of an output signal of a first stage, to produce an input to a subsequent stage as elaborated herein, may facilitate exploitation of currently available hardware for performing atomic matrix-matrix multiplication operations for the purpose of calculating butterfly transforms.

According to some embodiments, butterfly module 120 may receive (e.g., from input 7 of FIG. 1) an arithmetic parameter N, representing an arithmetic property of computing device 1. For example, computing device 1 may be a GPU (e.g., a Tensor Core GPU) adapted to perform atomic matrix-matrix multiplication operations between two 16×16 matrices. In such embodiments, arithmetic parameter N have the value of 16, representing the computing device's arithmetic capability of performing 16×16 matrix-matrix multiplication operations.

According to some embodiments, butterfly module 120 may receive (e.g., from an A/D module 110 of FIG. 3, from input 7 of FIG. 1 and the like) an input tensor, or input data matrix 110B. For example, input data matrix 110B may have dimensions [M×B], representing a batch of B input data vectors, each of length M.

Butterfly module 120 may arrange the input data matrix 110B into S section matrices 123 of dimensions [N×K] (e.g., N rows×K columns), wherein K>=N and K<=B. Section matrices 123 are denoted as SE(i, j) 123 in FIG. 4, where i represents the stage (e.g., i=0 for stage ST0, i=1 for stage ST1, etc.) and j represents the index of a section 123 within a stage level (e.g., jϵ[0, (S−1)]).

According to some embodiments, S may be calculated as the quotient value of (M/N), rounded to the next power of 2. For example, the input data vectors may be of length M=256, and the batch size B may be 1024. In this example, butterfly module 120 may arrange input data matrix 110B to S=M/N=256/16=16 section matrices 123. The dimensions of each section matrix 123 may be determined as [N×K]=[16×K], where K is a value between N and B. Pertaining to the example of the Tensor Core GPU, where N may be 16, K may be selected between 16 and 1024.

In some embodiments, K may be selected as an integer a product of N, allowing multiplication of each section matrix with an [N×N] matrix by a atomic [N×N] matrix-matrix multiplication operations. Pertaining to the example of the Tensor Core GPU, N may have the value of 16, and K may be selected to be 32. This may allow multiplication of each [16×32] section matrix with an [16×16] matrix, using two atomic [16×16] matrix-matrix multiplication operations.

Additionally, or alternatively K may be selected to optimally utilize a cache memory 9 of computing device 1. For example, the processor 2 of computing device 1 may include or may be associated with a cache memory device 9 of a predefined size CS. Butterfly module 120 may selecting the value of K, so as to optimally utilize cache memory size CS for the atomic [N×N] matrix multiplication operations. The term “optimally” may be used in this context in a sense that a maximal size of K may be selected, so as to import a maximal quantity of information from input data vectors into cache 9, according to cache size CS, to perform the atomic [N×N] matrix multiplication operations directly from cache memory 9.

As elaborated herein, in each stage, butterfly module 120 may process each section matrix separately, using at least one atomic [N×N] (e.g., 16×16) matrix-matrix multiplication operation.

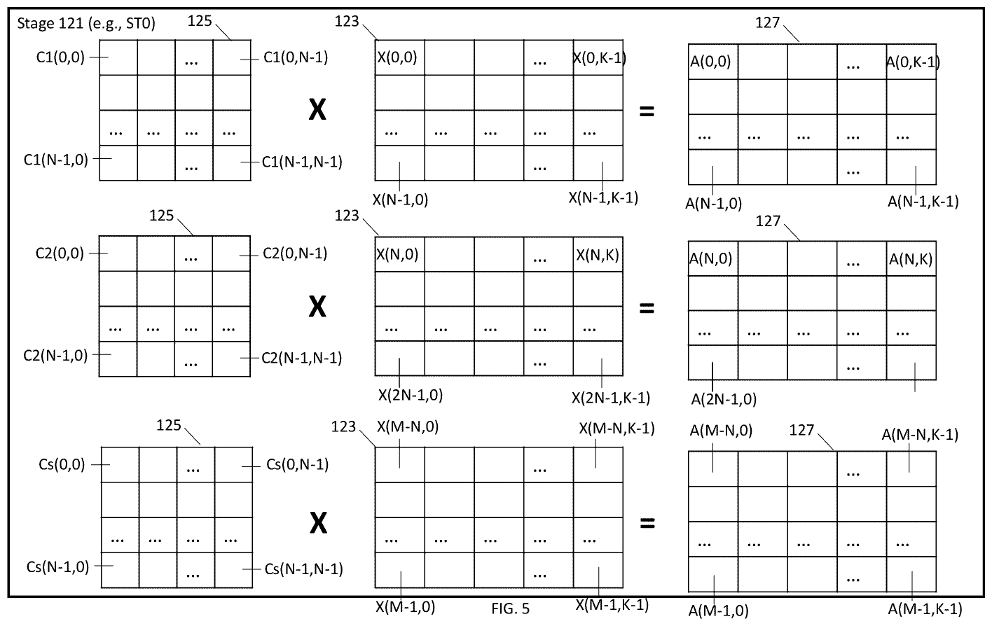

Reference is now made to FIG. 5, which is a schematic diagram depicting an example of calculation of a stage of the butterfly transform, in a stage module 121 that may be included in a butterfly transform calculation module 120, according to some embodiments.

As shown in FIG. 5, the plurality of S section matrices 123 each include a plurality of [N×K] entries, denoted X(i, j), where i is a row index and j is a column index. The example of FIG. 5 depicts the exemplary function of stage 121 ST0 (e.g., an input-level stage). Therefore, X(i, j) entries of the example of FIG. 5 represent elements of input data matrix or tensor 110B.

According to some embodiments, butterfly module 120 may receive (e.g., from a database 6 or an input device 7 of FIG. 1), a plurality of [N×N] (e.g., 16×16) coefficient matrices 125, representing weights or coefficients of the butterfly transform. The coefficients of coefficient matrices 125 are denoted in FIG. 5 elements Cj(m,n), where j denotes an index of the relevant coefficient matrix 125, and m and n denote an index or position within each coefficient matrix 125.

For example, stage 121 may handle multiplication of the S section matrices 123 by corresponding S coefficient matrix 125. In such embodiments, j may represent the index of a section matrix 123 within stage 121 (e.g., jϵ[0, (S−1)]), and m and n may be in the range of [0, (N−1)] (e.g., [0, . . . , 15]).

Additionally, or alternatively, butterfly module 120 may calculate the plurality of [N×N] coefficient matrices based on the type of the relevant calculated butterfly transform.

For example, butterfly module 120 may receive (e.g., from input 7 and/or storage 6 of FIG. 1) lookup table (LUT), which may include the coefficient values that correspond to a combination of: (a) a butterfly transform type (e.g., FFT, DCT, etc.); (b) a stage; and (c) a section within a stage. Butterfly module 120 may extract, for each coefficient matrix 125, the relevant coefficient values, and may perform atomic matrix-matrix computation operations using the extracted coefficient values, as elaborated herein.

According to some embodiments, butterfly transform computation module 120 may perform an iterative process of atomic [N×N] matrix-matrix multiplication operations between the [N×K] section matrices 123 and corresponding [N×N] coefficient matrices 125, to produce an output matrix O (e.g., output 120A of FIG. 4), which represents a result or output of the butterfly transform on the batch 110B of B input vectors 110B′. The term “iterative” may be used in this context to indicate a repetition of the atomic [N×N] matrix-matrix multiplication operations between stages 121.

For example, as depicted in the example of FIG. 5, stage 121 ST0 may be an input-level stage in a sense that it may receive values of input vectors 110B′ as input. Stage 121 ST0 may calculate the product of multiplication of section matrices 123 with corresponding coefficient matrices 125, using atomic [N×N] matrix-matrix multiplication operations to produce interim, [N×K] result matrices 127. The entries of the [N×K] interim matrices 127 are denoted herein as A(i, j), where i is a row index and j is a column index. The content of interim matrices 127 (e.g., A(i, j)) may be rearranged or swizzled as elaborated herein, and may be used as operand in a subsequent iteration of atomic [N×N] matrix-matrix multiplication with relevant coefficient matrices 125, in a subsequent stage 121.

The term “iteration” may further be used in this context in a sense of memory re-usage throughout the butterfly transform computation. For example, system 100 may perform a portion of the butterfly transform algorithm, extending through a plurality of stages 121, by a single GPU processing kernel. The GPU processing kernel may use the same cache memory 9 for the atomic multiplication operations and swizzling of multiplication products throughout the stages, and may do so with minimal intermediate access to a Random Access Memory device (RAM) associated with the kernel. It may be appreciated that the value of the K parameter may be based on the allocated cache memory 9 CS, so as to facilitate such iterative process without accessing an external (e.g., RAM) memory device.

According to some embodiments, butterfly module 120 may calculate a number of stages or iterations R of the iterative butterfly transform computation process, based on the length of the input vectors 110B′, denoted herein as parameter M.

For example, as elaborated herein, a computing device such as the Tensor Core GPU may be configured to perform [16×16] matrix-matrix multiplication operations atomically. Therefore, the Tensor Core GPU may perform the computations of a 4-level butterfly diagram using an atomic [16×16] matrix-matrix multiplication operation. As shown in the example of FIG. 2, a 4-level butterfly diagram may represent, or facilitate computation of a butterfly transform of an input vector 110B′ that is up to 16 elements long. Thus, the number of stages or iterations (R) required by the Tensor Core GPU to perform a butterfly transform computation for such an input vector 110B′ is 1.

In another example, an input vector 110B′ that is between 17 elements and 256 elements long would require at least a 5-level butterfly diagram. Therefore, the number of stages or iterations (R) required by the Tensor Core GPU to perform a butterfly transform computation for such an input vector 110B′ is 2. The number of iterations (R) required by the Tensor Core GPU for an input vector 110B′ that is between 257 elements and 4096 elements long is 3, and so forth.

As elaborated herein (e.g., in relation to FIG. 4), butterfly module 120 may repeat the iterative process of atomic [N×N] matrix-matrix multiplication operations R number of iterations or stages 121 (e.g., ST0, ST1, etc.). The terms “stage” and “iteration” may be used herein interchangeably in this context.

As shown in FIG. 5, in each stage 121 or iteration of the R iterations, butterfly module 120 may perform at least one atomic [N×N] matrix-matrix multiplication operation between each section matrix 125 of the S section matrices 123 and a corresponding coefficient matrix 123. Butterfly module 120 may thus obtain S [N×K] interim matrix 127 (each being a product of an [N×N] matrix-matrix multiplication operation).

It may be appreciated that the number of atomic [N×N] matrix-matrix multiplication operations required to obtain each interim matrix 127 is defined by the value of the parameter K. For example, when K=N, then one [N×N] matrix-matrix multiplication operation will be required to obtain the respective [N×K] interim matrix 127. If K is an integer product of N, e.g., K=aN, then a [N×N] matrix-matrix multiplication operation will be required.

As elaborated herein (e.g., in relation to FIG. 4), in one or more (e.g., each) iterations, swizzle module 122 of butterfly module 120 may rearrange or swizzle the N rows of each of the S interim matrices 127, to produce S new [N×K] section matrices 123. These new [N×K] section matrices 123 may serve as input for a subsequent iteration or stage, as elaborated here.

Additionally, or alternatively, butterfly module 120 may perform the rearrangement of rows of the S interim matrices 127 based on an index of a current iteration.

For example, if an index of the current iteration is R (e.g., when calculating the last iteration or stage 121), then butterfly module 120 may rearrange the N rows of the S interim matrices to produce the output matrix (e.g., output 120 of FIG. 4).

In a complementary manner, if the index of the current iteration is smaller than R (e.g., when calculating an inner stage 121 of the butterfly transform diagram) then butterfly module 120 may rearrange the N rows of the S interim matrices, to produce the S new [N×K] section matrices. Butterfly module 120 may then transfer the S new [N×K] section matrices as input for a subsequent iteration or stage 121.

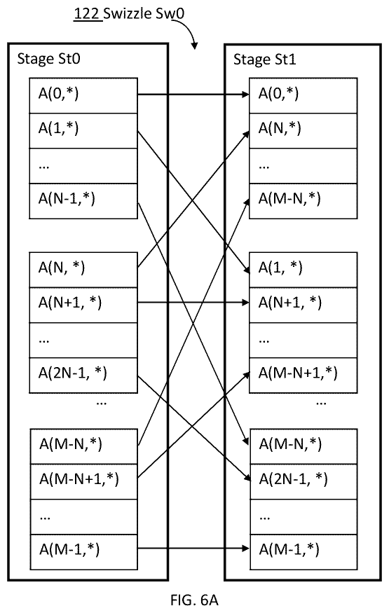

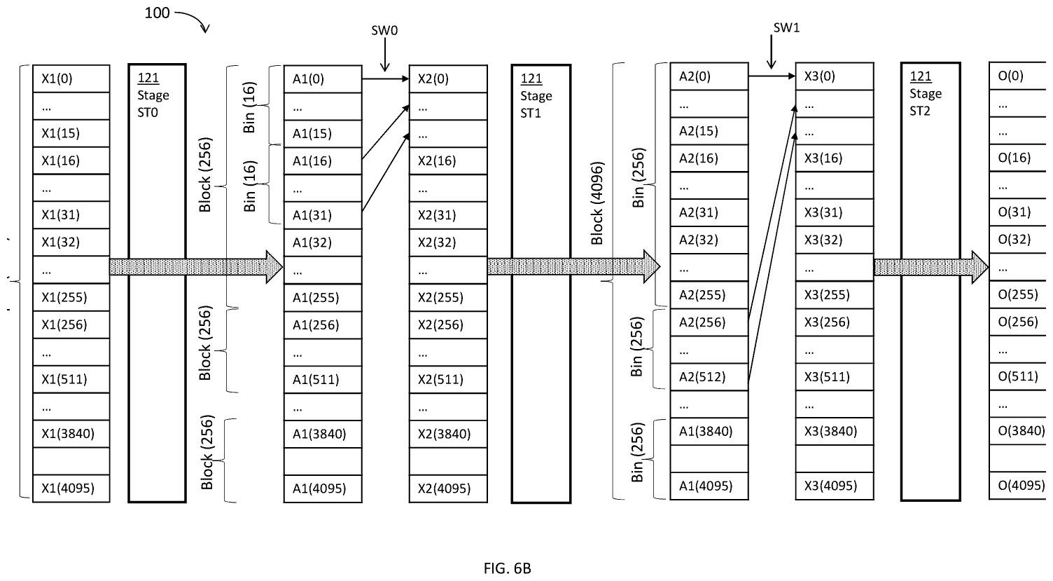

Reference is now made to FIG. 6A, which is a schematic diagram, depicting an example of a function of swizzle module 122, which may be included in a butterfly transform calculation module 120, according to some embodiments of the invention. In this example, input vector 110B′ length (denoted herein as parameter M) is 256.

As explained above, a butterfly transform of an input vector 110B′ of 256 elements may require log₂(256)=8 layers. Therefore, the number of stages (R) required by the Tensor Core GPU to perform a butterfly transform computation for such an input vector 110B′ is 2 (with each iteration implementing 4 layers).

The first 4 layers of the butterfly transform may be computed in stage 121 ST0 by atomic [N×N] matrix-matrix multiplication operations, as elaborated herein (e.g., in relation to FIG. 5). As the input vector 110B′ is 256 elements long, it contains S=16 section matrices 123, each of N=16 rows. In this example, each of the S=16 section matrices 123 may have been processed separately, and multiplied by a respective coefficient matrix 125, to produce a respective interim matrix 127.

It has been observed that the subsequent stage ST1 (e.g., implementing the next 4 layers of the butterfly transform algorithm) operates such that the elements of each i-th row of each section matrix 123 of stage ST0 are only combined with elements of the i-th row of the other section matrices 123 of stage ST0.

In other words, and as depicted by the arrows of FIG. 6A, the first row of elements from the first section matrix 123 of ST0 is combined only with the first row of elements of the other section matrices 123 of ST0; the second row of elements from the first section matrix 123 of ST0 is combined only with the second row of elements of the other section matrices 123 of ST0; etc.

According to some embodiments, the swizzle function of swizzle module 122 (e.g., rearrangement of rows of the interim matrices 127) may be performed according to a modulus value of the relevant row indices.

For example, swizzle module 122 may calculate, or may receive (e.g., via input 7 of FIG. 1) a bin size parameter value, based on the index of the current iteration or stage, as elaborated herein. For each row of the S interim matrices 127 of a current stage (e.g., ST0), swizzle module 122 may calculate a modulus of an index of the row, based on the bin size parameter value. Swizzle module 122 may subsequently rearrange the S×N rows of the S [N×K] interim matrices 127 to produce S new [N×K] section matrices 123, such that each new [N×K] section matrix 123 may include rows of the S interim matrices 127 that correspond to the same calculated modulus.

Pertaining to the example of FIG. 6A, where the input vector 110B′ is 256 elements long (e.g., M=256), the bin size parameter value (bin_size) of a specific stage (e.g., stage ST0) may be defined as 16. In this example, an element of index element_index in input vector 110B′ may be associated with, or assigned to a specific bin number (bin_number), according to Eq. 2 below:

$$bin\_number ( element\_index ) = element\_index modulus bin\_size \qquad Eq . 2$$

In this example, there are 16 elements per bin, and these elements are combined together in the next 4 levels of the butterfly transform algorithm, as depicted in the example of FIG. 6A.

Reference is now made to FIG. 6B which is a schematic diagram, depicting an example of a computation of a butterfly transform according to some embodiments of the invention.

In the example of FIG. 6A, the length of input vector 110B′ (denoted in FIG. 6B as elements [X1(0) . . . . X1(4095)]) may be equal to, or smaller than 4096 elements (e.g., M=4096). Alternatively, the length of input vector 110B′ ([X1(0) . . . . X1(4095)]) may be longer than 4096 elements long (e.g., M>4096), and may be truncated or handled separately in 4096 element-long chunks.

In this example of a 4096 element-long input vector 110B′, 3 stages 121 of matrix multiplication (e.g., ST0, ST1 and ST2) may be needed to realize the butterfly transform function. A swizzling module 122 may be inserted between each two consecutive stage modules 121, resulting a total of two swizzling modules 122 (e.g., SW0 and SW1), each preparing the respective section matrices for the subsequent iteration or stage module ST (e.g., ST1, ST2).

After performing the multiplication functions of stage 121 ST0, rows of the resulting interim matrices 127 (denoted in FIG. 6B as elements [A1(0) . . . . A1(4095)]) may be divided to 256-element long blocks, and the bin size parameter value of the first swizzling operator 122 (e.g., SW0, between ST0 and ST1) may be set to 16 (e.g., bin_size=16).

Subsequently, swizzling operator 122 (e.g., SW0, between ST0 and ST1) may rearrange the S×N rows of the S [N×K] interim matrices 127 to produce S×N new rows (denoted in FIG. 6B as elements [X2(0) . . . . X2(4095)]) of the new [N×K] section matrices 123, as shown by the arrows. Note that such a swizzling process with bin_size=16 is also elaborated herein, e.g., in relation to FIG. 6A.

In other words: all the first elements (e.g., [A1(0), A1(16), A1(31), . . . , A1(4080)]) of each bin_size (e.g., 16) group of rows of interim matrices 127 (e.g., [A1(0) . . . . A1(15); A1(16) . . . . A1(31); . . . ; A1(4080) . . . . A1(4095)] may be directed to the first section matrix 123 (e.g., [X2(0), . . . , X2(15)]);

All the second elements (e.g., [A1(1), A1(17), A1(32), . . . , A1(4081)]) of each bin_size (e.g., 16) group of rows of interim matrices 127 may be directed to the second section matrix 123 (e.g., [X2(16), . . . , X2(31)]);

All the third elements (e.g., [A1(2), A1(18), A1(33), . . . , A1(4082)]) of each bin_size (e.g., 16) group of rows of interim matrices 127 may be directed to the third section matrix 123 (e.g., [X2(32), . . . , X2(47)]), etc.

After performing the multiplication functions of the iteration of stage 121 ST1, rows of the resulting interim matrices 127 (denoted in FIG. 6B as elements [A2(0) . . . A2(4095)]) may be divided to 4096-element long blocks (in this example, a single block), and the bin size parameter value of the second swizzling operator 122 (e.g., SW1, between ST1 and ST2) may be set to 256 (e.g., bin_size=256).

Subsequently, swizzling operator 122 (e.g., SW1) may rearrange the S×N rows of the S [N×K] interim matrices 127 to produce S×N new rows (denoted in FIG. 6B as elements [X3(0) . . . . X3 (4095)]) of the new [N×K] section matrices 123, as shown by the arrows.

In other words: all the first elements (e.g., [A2(0), A2(256), A2(512), . . . , A2(3840)]) of each bin_size (e.g., 256) group of rows of interim matrices 127 may be directed to the first section matrix 123 (e.g., [X3(0), . . . , X(15)]);

all the second elements (e.g., [A2(1), A2(257), A2(513), . . . , A2(3841)]) of each bin_size (e.g., 256) group of rows of interim matrices 127 may be directed to the second section matrix 123 (e.g., [X3(16), . . . , X3(31)]), etc.

At the iteration of stage ST2 of the example of FIG. 6B, the new [N×K] section matrices 123 (consisting of elements [X3(0) . . . . X3(4095)]) may be atomically multiplied by respective [N×N] (e.g., 16×16) coefficient matrices 125, to produce outcome matrices O (e.g., output 120A of FIG. 4) that consist of row elements [O(0) . . . . O(4095)].

According to some embodiments, the bin size parameter value may be calculated as follows:

An initial bin_size value (e.g., used by the first swizzle module 122 SW0) may be 16. This number may be multiplied by 16 for each subsequent swizzle module 122 in the butterfly transform calculation flow. For example, the bin_size value for the second swizzle module 122 (e.g., SW1) may be 256, for the third swizzle module 122—the bin_size value may be 4096, etc. The respective block size may consistently be equal to the bin size value, multiplied by 16 (e.g., 256 for SW0, 4096 for SW1, etc.), thus ensuring 16 row elements for each section matrix 123.

It may be appreciated that the size of parameter K may be selected, based on the cache memory 9 size, so as to perform the function of stage modules 121 (e.g., the iterations of atomic matrix-matrix multiplication operations) from the cache memory 9. Such configuration may reduce or eliminate access of computing device 1 of butterfly module 120 to an external memory (e.g., RAM) device, and therefore may further improve throughput and/or latency of butterfly transform calculations by system 100.

For example, as part of the multiplication operations between an [N×K] section matrix 123 and a corresponding [N×N] coefficient matrix 125, stage module 121 may divide the [N×K] section matrix to a plurality of [N×N] sub-matrices (e.g., K/N sub-matrices). For each sub-matrix, stage module 121 may perform an atomic [N×N] matrix multiplication between the [N×N] sub-matrix and the corresponding [N×N] coefficient matrix. This atomic [N×N] matrix multiplication may be repeated for all sub-matrices of the section matrix. The value of parameter K may be selected so that stage module 121 may be able to accumulate the output of a plurality (e.g., all) atomic matrix multiplications pertaining to a single [N×K] section matrix 123 in the cache memory 9 of a single kernel of the processing unit (e.g., GPU). Thus, stage module 121 may produce at least one interim matrix of the S interim matrices from cache memory 9, with minimal access to an external RAM device.

The term “external” may be used in this context, in relation to processor 2 of FIG. 1, to refer to a memory device such as memory 4 of FIG. 1 and/or storage 6 of FIG. 1. It may be appreciated that such external memory may reside beyond a directly-mapped memory space of processor 2, and may be characterized by access times that are longer than the access time of cache memory 9.

Additionally, the size of parameter K may be selected, based on the cache memory 9 size, so as to perform both the function of stage modules 121 (e.g., the iterations of atomic matrix-matrix multiplication operations) and the function of swizzling module 122 (e.g., rearrangement of interim matrix 127 rows) from the cache memory 9.

In other words, butterfly module 120 may maintain one or more (e.g., S) [N×K] interim matrices 127 in cache memory 9 of a single kernel of the processing unit or GPU. Butterfly module 120 may rearrange or swizzle the one or more (e.g., S) rows of the [N×K] interim matrices to produce one or more (e.g., S) new [N×K] section matrices 123 within cache memory 9. Subsequently, butterfly module 120 may maintain the one or more (e.g., S) new [N×K] section matrices 123 in cache memory 9 of the single processing kernel for the subsequent iteration or stage of atomic matrix-matrix multiplication operations.

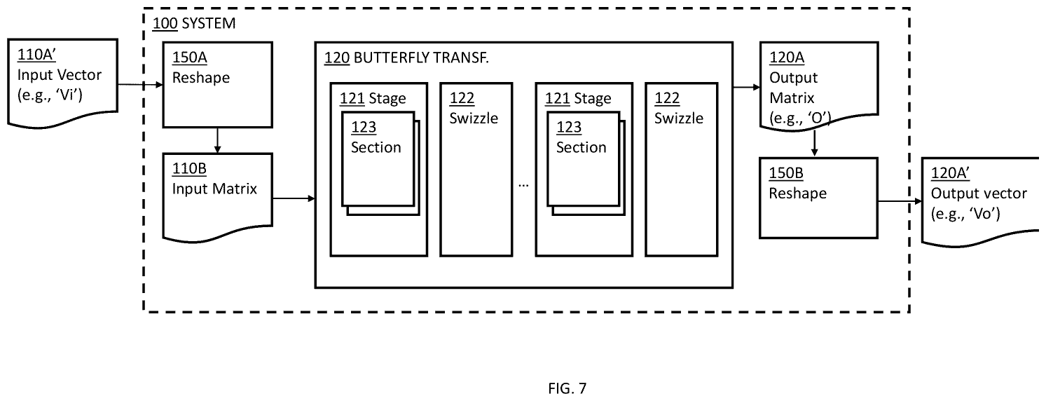

Reference is now made to FIG. 7, which is a schematic diagram depicting a system 100 for optimizing calculation of butterfly transforms, according to some embodiments of the invention. According to some embodiments, system 100 of FIG. 7 may be the same as system 100 of FIG. 3 and/or FIG. 6B.

As elaborated herein (e.g., in the example of FIG. 6B), system 100 may include a butterfly transform module 120, which may include: (a) stage modules 121, adapted to implement a plurality of iterative steps or stages of atomic [N×N] matrix-matrix multiplication operations, and (b) swizzle modules 122, separating each pair of stage modules 121, and adapted to perform the rearranging of interim output matrices 127.

According to some embodiments, system 100 may include additional modules, such as reshaping modules 150A and 150B, adapted to support unique features of FFT/IFFT and/or DFT/IDFT butterfly transforms.

For example, system 100 may receive (e.g., via a A/D module such as A/D 110 of FIG. 3) a digital signal (e.g., signal 110A of FIG. 3) that includes a vectoral representation of data elements. This vectoral signal is denoted in FIG. 7 as input vector Vi 110A′.

According to some embodiments, the butterfly transform may be an FFT transform, an inverse FFT transform, a DFT transform or an inverse DFT transform. In such embodiments, reshaping module 150A may receive input vector Vi 110A′, and reshape the initial input vector Vi to produce the input data matrix 110B of dimensions [M×B]. As elaborated herein, butterfly module 120 may compute the butterfly transform (e.g., FFT/IFFT/DFT/IDFT) on input data matrix 110B to produce output matrix 120A (e.g., matrix ‘O’). According to some embodiments, reshaping module 150A may subsequently reshape output matrix 120A to produce an output vector 120A′ (e.g., “Vo”), representing a result of the butterfly transform (e.g., FFT/IFFT/DFT/IDFT) on input vector 110A′ (“Vi”).

As known in the art, some butterfly transforms (e.g., DFT, IDFT) may include multiplication of complex numbers (e.g., having real and imaginary components). It may be appreciated that matrix-matrix multiplication between matrices A and B (e.g., C=A*B) involving complex numbers (e.g., A=(A^{real}+jA^{im}); B=(B^{real}+jB^{im})) may be performed by dividing each matrix to its real and imaginary parts, as follows:

$$C = A * B →︀$$

$$C = ( {A}^{real} + {jA}^{im} ) * ( {B}^{real} + {jB}^{im} ) →︀$$

$${C}^{real} + {jC}^{im} = [ ( {A}^{real} * {B}^{real} ) - ( {A}^{im} * {B}^{im} ) ] + j [ ( {A}^{real} * {B}^{im} ) - ( {A}^{im} * {B}^{real} ) ] .$$

In other words, butterfly module 120 may compute the butterfly transform by calculating each of the four components (e.g., (A^{real}*B^{real}), (A^{im}*B^{im}), (A^{real}*B^{im}), and (A^{im}*B^{real})) separately, e.g., in a separate, parallel computing process or thread, and then combine the outcome of the outcome of the four calculation threads into a comprehensive result of the butterfly transform.

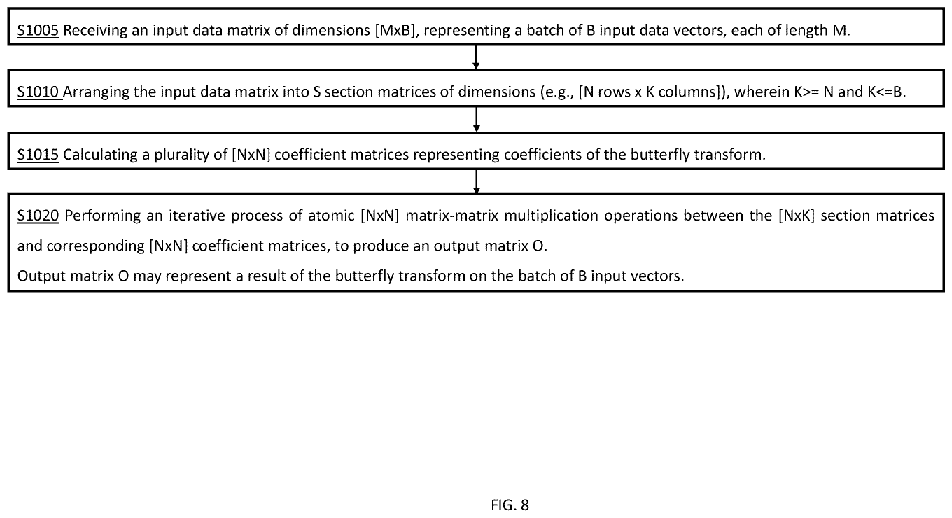

Reference is now made to FIG. 8, which is a flow diagram depicting a method of optimizing calculation of a butterfly transform (e.g., DFT) by a processing unit (e.g., computing device 1 of FIG. 1), according to some embodiments of the invention, where the processing unit is adapted to perform atomic [N×N] matrix-matrix multiplication operations.

As shown in step S1005, processing unit 1 may be configured to receive an input data matrix of dimensions [M×B], representing a batch of B input data vectors, each of length M.

As shown in step S1010, processing unit 1 may be configured to arrange the input data matrix into S section matrices (e.g., section matrices 123 of FIG. 4 or FIG. 5) of dimensions [N×K] (e.g., [N rows×K columns] or vice versa), wherein K>=N and K<=B.

As shown in step S1015, processing unit 1 may be configured to calculate a plurality of [N×N] coefficient matrices (e.g., matrices 125 of FIG. 5), representing coefficients of the butterfly transform.

As shown in step S1020, processing unit 1 may be configured to perform an iterative process of atomic [N×N] matrix multiplication operations between the [N×K] section matrices 123 and corresponding [N×N] coefficient matrices 125, to produce an output matrix O, as elaborated herein (e.g., in relation to FIGS. 5, 6A and 6B). Output matrix O may represent a result of the butterfly transform (e.g., DFT) on the batch of B input vectors.

As explained herein, the usage of butterfly transforms is ubiquitous in the art, and is found, for example, in nearly any type of system that provides computerized signal or image analysis. As elaborated herein, system 100 may optimize calculation of such butterfly transforms, and thereby provide a practical application for any underlying computerized application e.g., of signal or image analysis.

Additionally, and as elaborated herein, system 100 may leverage properties of currently available processing units, which are adapted to perform atomic [N×N] multiplication operations, to boost performance of butterfly transformation calculations.

Such boost in performance may include, for example higher throughput, and/or lower latency of butterfly transformation (e.g., FFT, DFT, DCT, etc.) calculations, and subsequent improvement in throughput, and/or latency of underlying applications (e.g., applications of signal and image processing).

Additionally, or alternatively, it may be appreciated by a person skilled in the art that such boost in performance of butterfly transformation calculations may include improvement in computer performance parameters, such as minimization of consumption of processing resources, including for example minimization of processing cycles, memory consumption, power consumption and the like.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of automatically optimizing calculation of a butterfly transform by a processing unit, the processing unit adapted to perform atomic [N×N] matrix multiplication operations, the method comprising:
receiving an input data matrix of dimensions [M×B], representing a batch of B input data vectors, each of length M;
arranging the input data matrix into S section matrices of dimensions [N rows×K columns], wherein K>=N and K<=B;
calculating a plurality of [N×N] coefficient matrices representing coefficients of the butterfly transform; and
performing an iterative process of atomic [N×N] matrix multiplication operations between the [N×K] section matrices and corresponding [N×N] coefficient matrices, to produce an output matrix O,
wherein output matrix O represents a result of the butterfly transform on the batch of B input vectors.

2. The method of claim 1, wherein the processing unit comprises a cache memory device of a predefined size CS, and wherein the method further comprising selecting the value of K, so as to optimally utilize cache memory size CS for the atomic [N×N] matrix multiplication operations.

3. The method of claim 1, further comprising calculating a number of iterations R of the iterative process based on M, and repeating the iterative process R number of iterations, wherein each iteration comprises, for each section matrix, performing at least one atomic [N×N] matrix multiplication operation between the section matrix and a corresponding coefficient matrix, to obtain S [N×K] interim matrices.

4. The method of claim 3, wherein each iteration further comprises rearranging the N rows of the S interim matrices to produce S new [N×K] section matrices, as input for a subsequent iteration.

5. The method of claim 3, wherein each iteration further comprises:
if an index of the current iteration is R, then rearranging the N rows of the S interim matrices to produce the output matrix; and
if otherwise, then rearranging the N rows of the S interim matrices to produce S new [N×K] section matrices, as input for a subsequent iteration.

6. The method of claim 4, wherein rearranging the S interim matrices comprises:
calculating a bin size parameter value, based on the index of the current iteration;
for each row of the S interim matrices, calculating a modulus of an index of the row, based on the bin size parameter value; and
rearranging the SxN rows of the S [N×K] interim matrices to produce S new [N×K] section matrices such that each new [N×K] section matrix comprises rows of the S interim matrices that correspond to the same calculated modulus.

7. The method of claim 4, wherein rearranging the N rows of an [N×K] interim matrix comprises:
maintaining the S [N×K] interim matrices in the cache memory of a single kernel of the processing unit;
rearranging rows of the S [N×K] interim matrices to produce S new [N×K] section matrices; and
maintaining the S new [N×K] section matrices in the cache memory of the single kernel for the subsequent iteration.

8. The method of claim 3, wherein performing multiplication operations between an [N×K] section matrix and a [N×N] coefficient matrix comprises:
dividing the [N×K] section matrix to a plurality of [N×N] sub-matrices;
for each sub-matrix, performing atomic [N×N] matrix multiplication between the sub-matrix and the corresponding [N×N] coefficient matrix;
repeating said atomic [N×N] matrix multiplication for all sub-matrices of the section matrix, and accumulating output of said atomic matrix multiplications in the cache memory of a single kernel of the processing unit, to produce at least one interim matrix of the S interim matrices.

9. The method of claim 1, wherein the butterfly transform is selected from a list consisting of a Fast Fourier Transform (FFT), an Inverse Fast Fourier Transform (IFFT), a Discrete Fourier Transform (DFT), and an Inverse Discrete Fourier Transform (IDFT), and wherein receiving an input data matrix comprises:
receiving an input vector Vi; and
reshaping the initial input vector Vi to produce the input data matrix of dimensions [M×B],
and wherein the method further comprises reshaping output matrix O, to produce an output vector Vo, representing a result of the butterfly transform on input vector Vi.

10. The method of claim 1, wherein the processing unit is a Tensor Core Graphic Processing Unit (GPU), configured to perform the at least one [N×N] matrix multiplication in a single computing cycle.

11. The method of claim 1, wherein the butterfly transform is selected from a list consisting of: a Fast Fourier Transform (FFT), an Inverse Fast Fourier Transform (IFFT), a Discrete Fourier Transform (DFT), an Inverse Discrete Fourier Transform (IDFT), a Discrete Cosine Transform (DCT), an Inverse Discrete Cosine Transform (IDCT), a Discrete Sine Transform (DST), and an Inverse Discrete Sine Transform (IDST).

12. A system for automatically optimizing calculation of a butterfly transform, the system comprising: a non-transitory memory device, wherein modules of instruction code are stored, and at least one processor associated with the memory device, and configured to execute the modules of instruction code, whereupon execution of said modules of instruction code, the at least one processor is configured to:
receive an input data matrix of dimensions [M×B], representing a batch of B input data vectors, each of length M;
arrange the input data matrix into S section matrices of dimensions [N rows×K columns], wherein K>=N and K<=B;
calculate a plurality of [N×N] coefficient matrices representing coefficients of the butterfly transform; and
perform an iterative process of atomic [N×N] matrix multiplication operations between the [N×K] section matrices and corresponding [N×N] coefficient matrices, to produce an output matrix O, wherein output matrix O represents a result of the butterfly transform on the batch of B input vectors.

13. The system of claim 12, further comprising a cache memory device of a predefined size CS, and wherein the at least one processor is further configured to select the value of K, so as to optimally utilize cache memory size CS for the atomic [N×N] matrix multiplication operations.

14. The system of claim 12, wherein the at least one processor is further configured to:
calculate a number of iterations R of the iterative process based on M;
and repeat the iterative process R number of iterations,
wherein each iteration comprises, for each section matrix, performing at least one atomic [N×N] matrix multiplication operation between the section matrix and a corresponding coefficient matrix, to obtain S [N×K] interim matrices.

15. The system of claim 14, wherein the at least one processor is further configured to, in each iteration, rearrange the N rows of the S interim matrices to produce S new [N×K] section matrices, as input for a subsequent iteration.

16. The system of claim 14, wherein the at least one processor is further configured to, in each iteration:
if an index of the current iteration is R, then rearrange the N rows of the S interim matrices to produce the output matrix; and
if otherwise, then rearrange the N rows of the S interim matrices to produce S new [N×K] section matrices, as input for a subsequent iteration.

17. The system of claim 15, wherein the at least one processor is configured to rearrange the S interim matrices by:
calculating a bin size parameter value, based on the index of the current iteration;
for each row of the S interim matrices, calculating a modulus of an index of the row, based on the bin size parameter value; and
rearranging the S×N rows of the S [N×K] interim matrices to produce S new [N×K] section matrices such that each new [N×K] section matrix comprises rows of the S interim matrices that correspond to the same calculated modulus.

18. The system of claim 17, wherein the at least one processor is configured to rearrange the N rows of an [N×K] interim matrix by:
maintaining the S [N×K] interim matrices in the cache memory of a single kernel of the processing unit;
rearranging rows of the S [N×K] interim matrices to produce S new [N×K] section matrices; and
maintaining the S new [N×K] section matrices in the cache memory of the single kernel for the subsequent iteration.

19. The system of claim 14, wherein the at least one processor is configured to perform multiplication operations between an [N×K] section matrix and a [N×N] coefficient matrix by:
dividing the [N×K] section matrix to a plurality of [N×N] sub-matrices;
for each sub-matrix, performing atomic [N×N] matrix multiplication between the sub-matrix and the corresponding [N×N] coefficient matrix;
repeating said atomic [N×N] matrix multiplication for all sub-matrices of the section matrix, and accumulating output of said atomic matrix multiplications in the cache memory of a single kernel of the processing unit, to produce at least one interim matrix of the S interim matrices.

20. The system of claim 12, wherein the butterfly transform is selected from a list consisting of a Fast Fourier Transform (FFT), an Inverse Fast Fourier Transform (IFFT), a Discrete Fourier Transform (DFT), and an Inverse Discrete Fourier Transform (IDFT), and wherein the at least one processor is configured to:
receive an input data matrix by (i) receiving an input vector Vi, and (ii) reshaping the initial input vector Vi to produce the input data matrix of dimensions [M×B];
and reshape output matrix O, to produce an output vector Vo, representing a result of the butterfly transform on input vector Vi.

21.-22. (canceled)
